(19) United States
(12) Patent Application Publication
(10) Pub. No.: US 2023/0367300 A1
(43) Pub. Date: Nov. 16, 2023

(54) SYSTEM AND METHOD FOR OPTIMIZING SUPPLY CHAIN OF HYDROGEN DISTRIBUTION NETWORK

(71) Applicant: JIO PLATFORMS LIMITED, Ahmedabad (IN)

(72) Inventors: Akansha KUMAR, Hyderabad (IN); Anurag Vedprakash PANDEY, Navi Mumbai (IN); Athira SURENDRAN, Thrissur (IN); Ameya MUNAGEKAR, Mumbai (IN)

(21) Appl. No.: 18/246,518

(22) PCT Filed: Mar. 29, 2022
(86) PCT No.: PCT/IB2022/052867

§ 371 Date: Mar. 24, 2023

(30) Foreign Application Priority Data
Mar. 31, 2021 (IN) 202121014780

(51) Int. Cl. G05B 19/418; H01M 8/04082; H01M 8/22; H01M 8/00; G01F 15/061; G06Q 10/0832; G06Q 10/0833; G06Q 10/0835

(52) U.S. Cl. CPC G05B 19/41865; H01M 8/04201; H01M 8/22; H01M 8/004; G01F 15/061; G06Q 10/0832; G06Q 10/0833; G06Q 10/08355; H01M 2250/10

(57) ABSTRACT

The present disclosure generally relates to producing, transporting, distributing, and storing hydrogen fuel, more particularly to system and method for optimizing supply chain of hydrogen distribution network. A centralized server triggers production facility to produce gas/liquid Hydrogen. Centralized server stores at storage facility in hydrogen cylinders, produced gas/liquid Hydrogen, in Liquid Organic Hydrogen Carrier (LOHC) molecule, based on hydrogenation of chemicals. Centralized server transmits instructions for transporting hydrogenated LOHC molecule in tanker trucks, from production facility to depots, and dehydrogenates at depots, hydrogenated LOHC molecule to release hydrogen at low pressure. Centralized server compresses, at depots, released hydrogen, and fill compressed hydrogen in high-pressure tube trailers/flat-bed cylinder cascades. Centralized server determines optimal routes for transportation vehicles from depots to retailers/consumption sites, and stores, at retailers/consumption sites, compressed hydrogen in low-pressure tanks/high-pressure buffer cylinders. Centralized server outputs information corresponding to inventory of low-pressure tanks/high-pressure buffer cylinders at retailers/consumption sites.

### RESERVATION OF RIGHTS

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to producing, transporting, distributing, and storing hydrogen fuel. More particularly, the present disclosure relates to a system and a method for optimizing supply chain of hydrogen distribution network.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In general, reducing Carbon di-Oxide (CO₂) emissions may be a global priority. Further, enforcement of a CO₂ tax, stringent regulations, and investment in renewables maybe some of the mitigation strategies. The energy storage issue may need to be decisively addressed for a smooth transition to renewable energy. Hydrogen (H₂) may be regarded as a clean energy carrier. However, low density at ambient conditions of the H₂ may have challenges in storage and transportation. Currently, there may be three techniques for increasing a density of H₂ at ambient temperature, that are promising as supply chain options, which includes (i) compressing the hydrogen to high pressure to a pressure above 350 bar (referred to as Compressed Gas Hydrogen (CGH₂)), (ii) liquifying hydrogen at a temperature of −200 to −250° C. (referred to as liquid hydrogen or liquid H₂), and (iii) storing hydrogen in a Liquid Organic Hydrogen Carrier (LOHC) molecule by hydrogenation of chemicals such as Toluene or Di-Benzyl Toluene (DBT). In the case of Compressed Gas Hydrogen (CGH₂), the H₂ produced at the production facility may be compressed and stored in 350-900 bar tanks and subsequently transferred to high-pressure tube-trailers or flatbed cylinder cascade on trucks at pressures of 200-700 bar. The trailers/trucks carry H₂ to the Hydrogen Refueling Station (HRS) where the H₂ may be stored in low pressure (50 bar) tanks. Alternatively, the cylinder cascade from the truck may be detached and stored at the site. The empty truck returns to the production site. At the HRS, H₂ may be pressured from 50 bar to 500-900 bar and stored in high-pressure buffer cylinders for metering into onboard cylinders of the vehicle at 350 bar in case of heavy vehicles or 700 bar in case of car/taxi. In the case of liquid hydrogen, the H₂ produced at the production facility may be liquified at −200 to −250 C and stored locally in large cryogenic double insulated tanks. The liquid hydrogen may be then transferred to cryogenic double insulated tanks on trucks for transportation to refueling stations, where liquid hydrogen may be transferred into local cryogenic double insulated tanks, and the empty truck returns for recharging. At the refueling stations, liquid hydrogen may be cryo-pumped and compressed to 500-900 bar into buffer cylinders for dispensing to vehicles as in the case of Compressed Gas Hydrogen (CGH₂). In the case of LOHC, the H₂ produced at the production facility may be stored in the LOHC molecule by hydrogenation of chemicals such as Toluene or Di-benzyl Toluene (DBT), and the hydrogenated LOHC can be stored and transported to consumption sites using the same infrastructure that may be already in use for diesel/petrol. At the consumption sites, the LOHC can be stored in underground tanks for dehydrogenation to release the hydrogen at low pressure for storage in 50 bar pressure tanks, from where it can be compressed to 500-900 bar for storage into high-pressure buffer cylinders for dispensing to vehicles as in case of Compressed gas Hydrogen and liquid hydrogen.

However, each of the aforementioned techniques may have respective advantages and disadvantages. For example, Compressed Gas Hydrogen (CGH₂) may require 2-4 kWh/kg of H₂ for compression, and the technology becomes economical for the supply of H₂ up to 1-2 Temperature-programmed desorption (TPD) and for a distance of less than 300-500 km (return trip). This may be used in supply chains at high pressures up to 700 bar. However, in some places, the transportation of H₂ may be restricted to 200-250 bar at the moment. Regarding the LOHC, it can store 5-6 weight percentage of H₂, making it possible to transport 4-5 times more H₂ by LOHC than CGH₂ in a given truck. Further, being liquid at ambient conditions, LOHC may be easy to handle, transport, and store using the same infrastructure as liquid fuels. Since one of the chemicals used for storing H₂, i.e., DBT, may be non-flammable and non-explosive, and lower risk than the other, i.e., Toluene, for transportation and storage. However, dehydrogenation of LOHC may require 9-10 kWh of heat and is a major challenge for reducing the overall cost and efficiency of the LOHC supply chain. Further, the LOHC technology is still in a nascent stage with limited global demonstrations. As regards liquid hydrogen (LH₂), liquefaction may require high energy input (10 kWh per kg of H₂), however, this is compensated by increased H₂ carried (2-7 times more than CGH₂) on the same vehicle. In general, the LH₂ supply chain may be economically feasible only when the demand for H₂ is beyond 30-50 TPD and transportation is required for long-distance.

Considering the requirement to transport H₂ under different conditions, such as from the production facilities to depots, and from depots to the consumption sites, each requiring handling of different volumes and transportation over different distances, there is a need to arrive at the appropriate supply chain, based on use-case scenario, and further need to optimize the inventory, route, and storage of Hydrogen in a distribution network.

### OBJECTS OF THE PRESENT DISCLOSURE

Some of the objects of the present disclosure, which at least one embodiment herein satisfy are as listed herein below.

In a general aspect, the present disclosure provides a system and a method for optimizing the supply chain of the hydrogen distribution network.

In another aspect, the present disclosure enables transporting, distributing, and storing hydrogen to meet requirements at consumption sites, such as but not limited to retailers, refueling stations for fueling vehicles being run on hydrogen as a clean fuel, and other consumers, who may be using hydrogen a source of energy.

In another aspect, the present disclosure helps in transporting the hydrogen from the production facility to depots based on a Liquid Organic Hydrogen Carrier molecule (LOHC) technology and from the depots to consumption sites as Compressed Gas Hydrogen (CGH₂). The LOHC technology may enable to transport of 4-5 times more H₂ than Compressed Gas Hydrogen (CGH₂) in a given truck. Further, being liquid at ambient conditions, LOHC is easy to handle, transport, and store using the same infrastructure as liquid fuels. Since one of the chemicals used for storing H₂, i.e., Di-benzyl Toluene DBT, is non-flammable and non-explosive, it has a lower risk than the other, i.e., Toluene, for transportation and storage.

In yet another aspect, the present disclosure helps in finding optimal routes from the depots to the consumption sites, such as refueling stations for vehicles, with the objective of distance minimization and vehicle capacity satisfaction, that cover the daily requirement of all consumption sites, and further include optimizing, dispatch of H₂ on each route and for each consumption sites.

### SUMMARY

This section is provided to introduce certain objects and aspects of the present invention in a simplified form that are further described below in the detailed description. This summary is not intended to identify the key features or the scope of the claimed subject matter.

In an aspect, the present disclosure provides a system for optimizing supply chain of hydrogen distribution network. The system includes a production facility, a storage facility communicatively coupled to the production facility, one or more depots communicatively coupled to the storage facility, one or more retailers or consumption sites communicatively coupled to the one or more depots, a centralized server which includes a processor and a memory coupled to the processor, wherein the memory comprises processor-executable instructions. The system triggers the production facility to produce at least one of a gas Hydrogen and a liquid Hydrogen. Further, the system stores at the storage facility in one or more hydrogen cylinders, the produced at least one of the gas Hydrogen and the liquid Hydrogen, in a Liquid Organic Hydrogen Carrier (LOHC) molecule, based on hydrogenation of chemicals. Furthermore, the system transmits instructions for transporting the hydrogenated LOHC molecule in one or more tanker trucks, from the production facility to one or more depots. Thereafter, the system dehydrogenates at the one or more depots, the hydrogenated LOHC molecule to release the hydrogen at low pressure, upon receiving the one or more tanker trucks at the one or more depots. Further, the system compress, at the one or more depots, the released hydrogen and fill the compressed hydrogen in one or more high-pressure tube trailers or flat-bed cylinder cascades. Furthermore, the system determines one or more optimal routes for one or more transportation vehicles for distribution of the one or more high-pressure tube trailers or flat-bed cylinder cascades from the one or more depots to one or more retailers or consumption sites. Furthermore, the system receives information from the one or more retailers or the consumption sites, upon arrival of the one or more transportation vehicles to the one or more retailers or consumption sites. Thereafter, the system stores, at the one or more retailers or the consumption sites, the compressed hydrogen in one or more low-pressure tanks or one or more high-pressure buffer cylinders. Further, the system outputs information corresponding to an inventory of the one or more low-pressure tanks or one or more high-pressure buffer cylinders at the one or more retailers or the consumption sites.

In another aspect, the present disclosure further provides a method for optimizing supply chain of hydrogen distribution network. The method includes triggering the production facility to produce at least one of a gas Hydrogen and a liquid Hydrogen. Further, the method includes storing at the storage facility in one or more hydrogen cylinders, the produced at least one of the gas Hydrogen and the liquid Hydrogen, in a Liquid Organic Hydrogen Carrier (LOHC) molecule, based on hydrogenation of chemicals. Furthermore, the method includes transmitting instructions for transporting the hydrogenated LOHC molecule in one or more tanker trucks, from the production facility to one or more depots. Thereafter, the method includes dehydrogenating at the one or more depots, the hydrogenated LOHC molecule to release the hydrogen at low pressure, upon receiving the one or more tanker trucks at the one or more depots. Further, the method includes compressing, at the one or more depots, the released hydrogen and filling the compressed hydrogen in one or more high-pressure tube trailers or flat-bed cylinder cascades. Furthermore, the method includes determining one or more optimal routes for one or more transportation vehicles for distribution of the one or more high-pressure tube trailers or flat-bed cylinder cascades from the one or more depots to one or more retailers or consumption sites. Furthermore, the method includes receiving information from the one or more retailers or the consumption sites, upon arrival of the one or more transportation vehicles to the one or more retailers or consumption sites. Thereafter, the method includes storing, at the one or more retailers or the consumption sites, the compressed hydrogen in one or more low-pressure tanks or one or more high-pressure buffer cylinders. Further, the method includes outputting information corresponding to an inventory of the one or more low-pressure tanks or one or more high-pressure buffer cylinders at the one or more retailers or the consumption sites.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that the invention of such drawings includes the invention of electrical components, electronic components, or circuitry commonly used to implement such components.

FIG. 1 illustrates an exemplary network architecture in which or with which the system of the present disclosure can be implemented for optimizing the supply chain of the hydrogen distribution network, in accordance with an embodiment of the present disclosure.

FIG. 2 illustrates an exemplary representation of a centralized server for optimizing supply chain of the hydrogen distribution network, in accordance with an embodiment of the present disclosure.

FIG. 3 illustrates an exemplary flow diagram for optimizing the supply chain of the hydrogen distribution network, in accordance with an embodiment of the present disclosure.

FIG. 4 illustrates an exemplary routing diagram for the distribution of hydrogen cylinders from a depot to consumption sites, in accordance with an embodiment of the present disclosure.

FIG. 5 illustrates an exemplary graphical diagram for connected graph clusters for feasible routes, in accordance with an embodiment of the present disclosure.

FIG. 6 illustrates an exemplary flow diagram for a method of distribution of hydrogen from a production facility to consumption sites, in accordance with an embodiment of the present disclosure.

FIG. 7 illustrates an exemplary flow diagram for a method of optimization of the distribution of hydrogen from a depot to consumption sites, in accordance with an embodiment of the present disclosure.

FIG. 8 illustrates an exemplary method flow chart depicting a method for optimizing the supply chain of the hydrogen distribution network, in accordance with an embodiment of the present disclosure.

FIG. 9 illustrates an exemplary computer system in which or with which embodiments of the present invention can be utilized, in accordance with embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Various embodiments of the present disclosure provide a system and a method for optimizing the supply chain of the hydrogen distribution network. The present disclosure enables transporting, distributing, and storing hydrogen to meet requirements at consumption sites, such as but not limited to retailers, refueling stations for fueling vehicles being run on hydrogen as a clean fuel, and other consumers, who may be using hydrogen a source of energy. The present disclosure helps in transporting the hydrogen from the production facility to depots based on a Liquid Organic Hydrogen Carrier molecule (LOHC) technology and from the depots to consumption sites as Compressed Gas Hydrogen (CGH₂). The LOHC technology may enable to transport of 4-5 times more H₂ than Compressed Gas Hydrogen (CGH₂) in a given truck. Further, being liquid at ambient conditions, LOHC is easy to handle, transport, and store using the same infrastructure as liquid fuels. Since one of the chemicals used for storing H₂, i.e., Di-benzyl Toluene DBT, is non-flammable and non-explosive, it has a lower risk than the other, i.e., Toluene, for transportation and storage. The present disclosure helps in finding optimal routes from the depots to the consumption sites, such as refueling stations for vehicles, with the objective of distance minimization and vehicle capacity satisfaction, that cover the daily requirement of all consumption sites, and further include optimizing, dispatch of H₂ on each route and for each consumption sites.

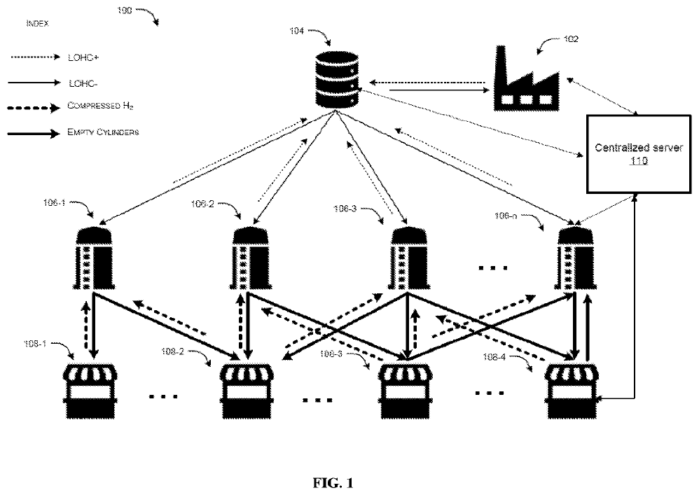

Referring to FIG. 1 that illustrates an exemplary network architecture for hydrogen distribution network optimizing system (100) (also referred to as network architecture (100)) in which or with which a centralized server (110) of the present disclosure can be implemented, in accordance with an embodiment of the present disclosure. The distribution network includes a hydrogen production facility, such as production facility (102), storage depots such as depots (106-1, 106-2, . . . 106-n) (individually referred to as depot (106) and collectively referred to as depots (106)), and consumption sites (108-1, 108-2, . . . 108-n) (individually referred to as composition site (108) and collectively referred to as consumption sites (108). The production facility (102) can include a storage (104). The storage facility (104) may be communicatively coupled to the production facility (102). Further, the depots (106) may be communicatively coupled to the storage facility (104). Further, the consumption sites (108) may also be one or more retailers. Further, the consumption sites (108) may be communicatively coupled to the one or more depots (106). The depots (106) may be geographically located to cater to requirements of consumption sites (108) located in a geographical area around the respective depots (106). Accordingly, the requirement of transporting hydrogen from the storage (104) of the production facility (102) to the depots (106) may be considerably higher than that from the depots (106) to the consumption sites (108). However, in order to minimize storage at the consumption sites (108), hydrogen cylinders need to be supplied to customer locations at a required frequency, which in some cases can be on a daily basis. Each hydrogen cylinder can store a fixed amount of hydrogen, for example, 250 Kilogram (Kg). The demand is in terms of the weight of hydrogen. Thus, mapped to several cylinders, the vehicles used for transportation shall have a fixed carrying capacity, such as a capacity of 4 cylinders. As compared to this, the depots (106) may have a relatively larger storage capacity.

Considering the above factors, the system and methods of the present disclosure propose to distribute hydrogen from the storage (104) of the production facility (102) to the depots using LOHC supply chain technology and from the depots (106) to the consumption sites (108) using compressed hydrogen supply chain technology, as shown in FIG. 1. Accordingly, the H₂ produced at the production facility (102) may be stored in the LOHC molecule by hydrogenation of chemicals such as, but are not limited to, Toluene or Di-benzyl Toluene (DBT). Further, the hydrogenated LOHC can be stored at the storage (104). From the storage (104), the LOHC can be transported to the depots (106) in tankers. At the depots (106), the LOHC can be dehydrogenated for releasing H₂, and the released H₂ can be compressed for onward transporting to the consumption sites (108) using, but are not limited to, high-pressure tube trailers or flat-bed cylinder cascades.

To optimize the supply chain from the depots (106) to consumption sites (108) considering that storage at the consumption sites (108) is to be minimized by daily supply, and the daily requirement of many of the consumption sites (108) shall be less than one full vehicle load. The objective of the optimization shall be to find the optimal quantity of cylinder dispatch each day and for each consumption site (108) for the given time horizon, minimizing the several vehicles in the time horizon specified, and minimizing the capital cost of storage used at the depot and the consumption sites (108). The optimization has to also take into account that the vehicles have a fixed capacity, such as a capacity to carry, for example, 4 cylinders, and a vehicle can travel a limited distance in a day, such as max 450 kilometers in a day. For example, if the distance is under 450 Km, it is considered as a whole day travel.

The centralized server (110) may be further operatively coupled to one or more computing devices (not shown in FIG. 1) associated with an entity (not shown in FIG. 1) or users. The entity may include a company, an organization, a network operator, a vendor, a retailer, a storage facilitator, a university, a lab facility, a business enterprise, a defence facility, or any other secured facility. Further, the entity may analyze the data or output from the centralized server (110). In some implementations, the system (110) may also be associated with the computing device. Further, the centralized server (110) may also be communicatively coupled to one or more electronic devices (not shown in FIG. 1) via a communication network of the network architecture (100).

Although FIG. 1 shows exemplary components of the network architecture (100), in other implementations, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

The centralized server (110) may be implemented in, but are not limited to, an electronic device, a mobile device, a wireless device, a wired device, a server, and the like. Such server may include, but are not limited to, a standalone server, a remote server, a cloud server, a dedicated server, and the like.

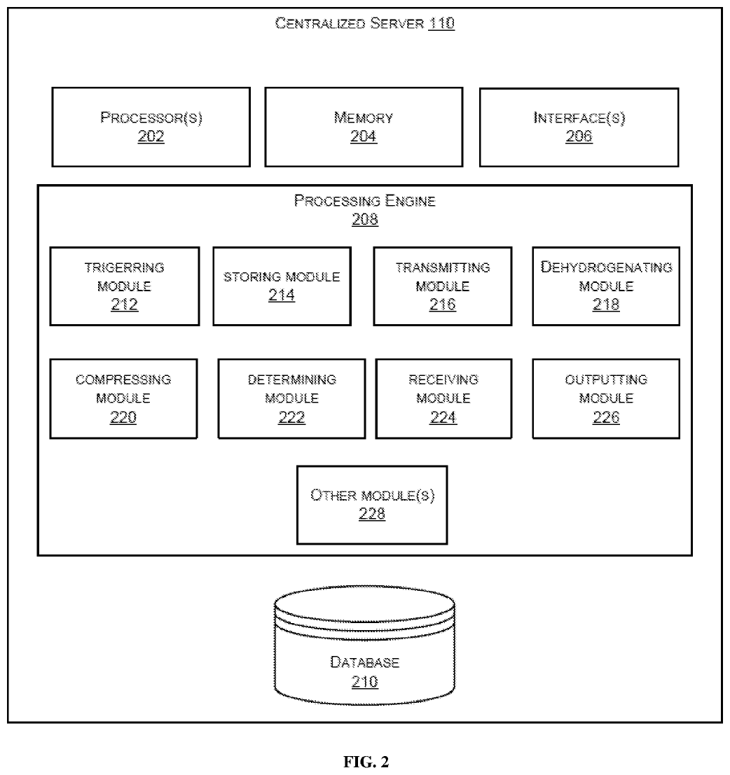

In an embodiment, the centralized server (110) may include one or more processors coupled with a memory, wherein the memory may store instructions which when executed by the one or more processors may cause the centralized server (110) to optimize the supply chain of hydrogen distribution network. An exemplary representation of the centralized server (110) for optimizing supply chain of the hydrogen distribution network, in accordance with an embodiment of the present disclosure, is shown in FIG. 2. In an aspect, the centralized server (110) may include one or more processor(s) (202). The one or more processor(s) (202) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the centralized server (110). The memory (204) may be configured to store one or more computer-readable instructions or routines in a non-transitory computer-readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the centralized server (110) may include an interface(s) (206). The interface(s) (206) may comprise a variety of interfaces, for example, interfaces for data input and output devices, referred to as I/O devices, storage devices, and the like. The interface(s) (206) may facilitate communication of the centralized server (110). The interface(s) (206) may also provide a communication pathway for one or more components of the centralized server (110). Examples of such components include, but are not limited to, processing unit/engine(s) (208) and a database (210).

The processing unit/engine(s) (208) may be implemented as a combination of hardware and programming (for example, programmable instructions) to implement one or more functionalities of the processing engine(s) (208). In the examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the centralized server (110) may include the machine-readable storage medium storing the instructions and the processing resource to execute the instructions, or the machine-readable storage medium may be separate but accessible to the centralized server (110) and the processing resource. In other examples, the processing engine(s) (208) may be implemented by electronic circuitry.

The processing engine (208) may include one or more modules/engines selected from any of a triggering module (212), a storing module (214), a transmitting module (216), a dehydrogenating module (218), a compressing module (220), a determining module (222), a receiving module (224), an outputting module (226), and other module(s) (228). The processing engine (208) may further be edge-based micro service event processing, but not limited to the like.

In an embodiment, the triggering module (212) may trigger the production facility (102) to produce at least one of a gas Hydrogen and a liquid Hydrogen. Further, the storing module (214) may store at the storage facility (104) in one or more hydrogen cylinders, the produced at least one of the gas Hydrogen and the liquid Hydrogen, in a Liquid Organic Hydrogen Carrier (LOHC) molecule, based on hydrogenation of chemicals. The hydrogenation of chemicals includes, but are not limited to, Toluene or Di-benzyl Toluene (DBT), and the hydrogenated LOHC can be stored at the storage.

In an embodiment, the transmitting module (216) may transmit instructions for transporting the hydrogenated LOHC molecule in one or more tanker trucks, from the production facility (102) to one or more depots (106). The depots (106) may be geographically located to cater to requirements of the one or more retailers or the consumption sites (108) located in a geographical area around the respective depots (106). The requirements may include transporting hydrogen from the storage facility (104) of the production facility (102) to the one or more depots (106) is highly considerable than that from the one or more depots (106) to the consumption sites (108).

In an embodiment, the dehydrogenating module (218) may dehydrogenate at the one or more depots (106), the hydrogenated LOHC molecule to release the hydrogen at low pressure, upon receiving the one or more tanker trucks at the one or more depots (106). Further, the compressing module (220) may compress, at the one or more depots (106), the released hydrogen and fill the compressed hydrogen in one or more high-pressure tube trailers or flat-bed cylinder cascades.

In an embodiment, the determining module (222) may determine one or more optimal routes for one or more transportation vehicles for distribution of the one or more high-pressure tube trailers or flat-bed cylinder cascades from the one or more depots (106) to one or more retailers or consumption sites (108). Determining the one or more optimal routes for one or more transportation vehicles further includes ascertaining iteratively vehicle routing problem for optimal routes, based on distance minimization and vehicle capacity satisfaction, for daily requirement of the one or more retailers or the consumption sites (108).

In an embodiment, the receiving module (224) may receive information from the one or more retailers or the consumption sites (108), upon arrival of the one or more transportation vehicles to the one or more retailers or consumption sites (108). Further, the storing module (214) may store, at the one or more retailers or the consumption sites (108), the compressed hydrogen in one or more low-pressure tanks or one or more high-pressure buffer cylinders. In an embodiment, the outputting module (226), output information corresponding to an inventory of the one or more low-pressure tanks or one or more high-pressure buffer cylinders at the one or more retailers or the consumption sites (108). Outputting further includes providing a graph with connected one or more retailers or the consumption sites (108) that would be served by the transportation vehicles via the one or more optimal routes. When the one or more retailers or the consumption sites (108) does not have a route in which the one or more retailers or the consumption sites (108) are connected to another one or more retailers or the consumption sites (108), such one or more retailers or the consumption sites (108) is considered independently.

In an embodiment, the electronic devices or the computing device (not shown in FIG. 1 and FIG. 2) may communicate with the centralized server (110) via set of executable instructions residing on any operating system, including but not limited to, Android™, iOS™, Kai OS™, and the like. In an embodiment, the electronic devices may include, but are not limited to, any electrical, electronic, electro-mechanical or an equipment or a combination of one or more of the above devices such as mobile phone, smartphone, virtual reality (VR) devices, augmented reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as a touchpad, touch-enabled screen, electronic pen and the like. It may be appreciated that the electronic devices may not be restricted to the mentioned devices and various other devices may be used. A smart computing device may be one of the appropriate systems for storing data and other private/sensitive information.

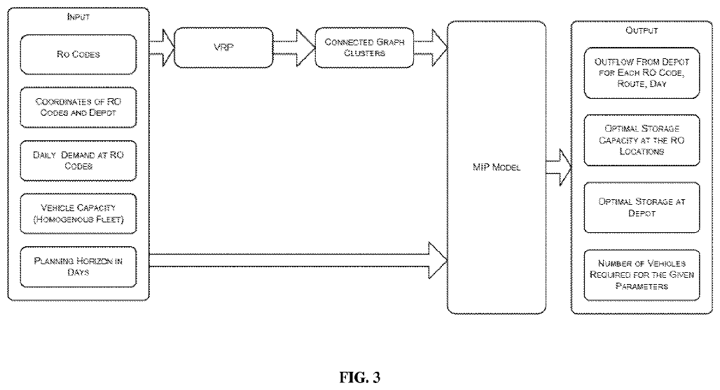

FIG. 3 illustrates an exemplary flow diagram for optimizing the supply chain of the hydrogen distribution network, in accordance with an embodiment of the present disclosure. To find out optimal routes for the vehicles, the inputs may include, but are not limited to, Route Optimization (RO) codes, co-ordination of RO codes and depots (106), daily demand at RO codes, vehicle capacity (homogeneous fleet), planning horizon in days, and the like. The centralized server (110) may first find out optimal routes for the vehicles using a Vehicle Routing Problem (VRP) technique. Thereafter, using the output from the VRP technique, the centralized server (110) may find the optimal outflow/dispatch of the hydrogen cylinders on each day for each route and for each customer by using a Mixed Integer Program (MIP) formulation.

It is to be appreciated that while the concept used for optimization and shown in FIG. 3 has been described with reference to the distribution of LOHC, the concept disclosed herein can be applied to other products as well, such as but are not limited to, liquid hydrogen, Ammonia, Methanol, and any other similar product, and the like, without any limitations whatsoever.

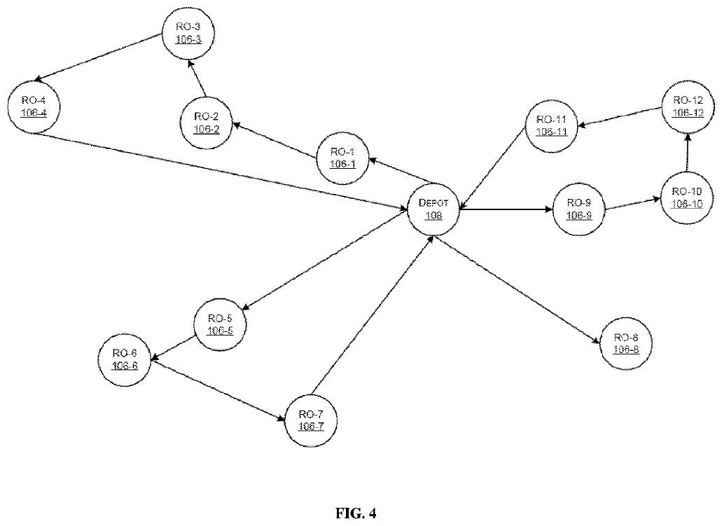

The Vehicle Routing Problem (VRP) technique may be used to find the optimal routes with the objective of distance minimization and vehicle capacity satisfaction. The VRP may be used to find all the possible feasible routes, such as shown in FIG. 4, which include the consumption sites (108) for the given daily demand. In an aspect, the VRP technique can be run iteratively by considering demands over a given period, such as by considering the demand of the next 4 days. The framework used can be, but not limited to, Google® or tools with Local Search heuristic, Meta-heuristics methodology, or Python®, and the like. The output from the VRP technique may be feasible routes, a distance of routes (TAT).

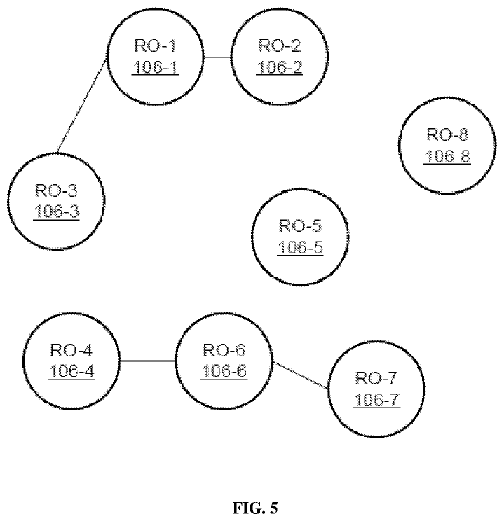

FIG. 5 illustrates an exemplary graphical diagram for connected graph clusters for feasible routes, in accordance with an embodiment of the present disclosure. The graph clusters may include a vehicle route schematic for distribution of hydrogen cylinders from the depot (106) to the retailers/consumption sites (108), as received as the output of the VRP technique. The graph may include connected consumption sites (108) that would be served by a vehicle, i.e., feasible routes for vehicles. In the output graph of the VRP, the corresponding depot (106) may be common for all the consumption sites (108) on the route as it is the start point and also the endpoint of each route. In some cases, it may happen that the consumption sites (108) may not have a route in which consumption sites (108) are connected to other consumption sites (108). Such consumption sites (108) can be considered independently.

In an embodiment, the output of the VRP technique may also include the distance of each of the feasible routes. The output of the VRP, i.e., feasible routes and distance of each of the feasible routes as well as other inputs can be to Mixed Integer Program (MIP) model, as shown in FIG. 3. Specifically, the MIP model may be formulated to find the optimal outflow/dispatch of the hydrogen cylinders on a given day for each route and for each customer. The framework used for MIP can be any of, but not limited to, Python, PuLP, and open sources such as CBC solver and commercial solvers used for testing, such as CPLEX, and the like. Further, the output of the MIP model maybe be optimal daily outflow/dispatch for each location and route, optimal storage at both, depot (106) and the customer locations, and several vehicles required daily on each route.

### Exemplary Scenario

Consider a scenario, which includes dataset consisting of 200 RO codes in a state. There may be a fixed demand on each day for the next 30 days for each RO code. The centralized server (110) may output total storage required at RO Codes maybe 64 cylinders, and several vehicles required maybe 516 vehicles, minimum storage required at depot maybe 65 cylinders. Further, the VRP model may be executed once and storing it offline for reuse. In an instance, the decision variables may be as shown below:
O_{ird}=Integer Variable ∀ (i,r,d)
   It is the outflow variable which indicates the quantity of outflow of cylinders for customer (i), on the day (d), on route (r)
I_{ird}=Integer Variable ∀ (i,r,d)
   It is the Inflow variable which indicates the quantity of Inflow of cylinders for customer (i), on the day (d), from the route (r)
Inventory_{id}=Integer Variable ∀ (i, d)
   It is the surplus inventory at the customer (i) on the day (d)
S_{d}=Integer Variable
   Storage at the depot
V_{rd}=Integer Variable
   It is the several vehicles on route (r) on the day (d)
Maxlnventoryᵢ=Integer Variable
   It is the minimum surplus inventory capacity required at the customer location
      Further, the parameters may include as shown below:
RouteDistanceᵣ=The Distance of the route “r”
StorageCostᵢ=The fixed cost of storage at customer location “i”
Vehicle Cost=The fixed cost of a vehicle
Vehicle Capacity=The capacity of the vehicle
   Further, the objective function may include as shown below:
Minimize (Transit Cost+Surplus Inventory Cost+Vehicle Cost)
Transit Cost=ΣᵣΣ_{d}V_{rd}*RouteDistanceᵣ*60
Surplus Inventory Cost=ΣiMaxInventoryᵢ*StorageCost*Days+Sd*StorageCost*Days
Vehicle Cost=ΣᵣΣ_{d}V_{rd}*VehicleFixedCost
   Further, one or more constraints may include as shown below:
Inflow, demand, and inventory constraint
   Inventory_{id}=Demand_{id}−ΣᵣI_{ird}+Inventory_{i(d-1}) ∀ (i∈Consumption sites, d∈Days)
Max Inventory at Consumption site constraint (Minimax of inventory)
   Σ_{d}Inventory_{id}≤MaxInventoryᵢ∀(i∈Consumption sites
Vehicle Capacity constraint: A vehicle cannot carry more than its capacity

$${V}_{r d} \leq ( \frac{{\sum }_{ier} {O}_{i r d}}{Vehicle Capacity} ) + 0.95 ∀ ( r in Routes , d in Days )$$

$${V}_{r d} \geq ( \frac{{\sum }_{ier} {O}_{i r d}}{Vicle Capacity} ) ∀ ( r in Routes , d in Days )$$

Inflow is equal to the outflow
   O_{ird}=I_{ir(d+tatr)}∀(i∈Consumption sites, r∈<Routes
Depot Storage constraint
   ΣᵢΣᵣO_{ird}≤Sd∀ (d in Days)
Non-Negativity Constraint
   O_{ird}, I_{rd}, Inventory_{id}, Sd, V_{rd}, MaxInventoryᵢ≥0 ∀(i, r, d).

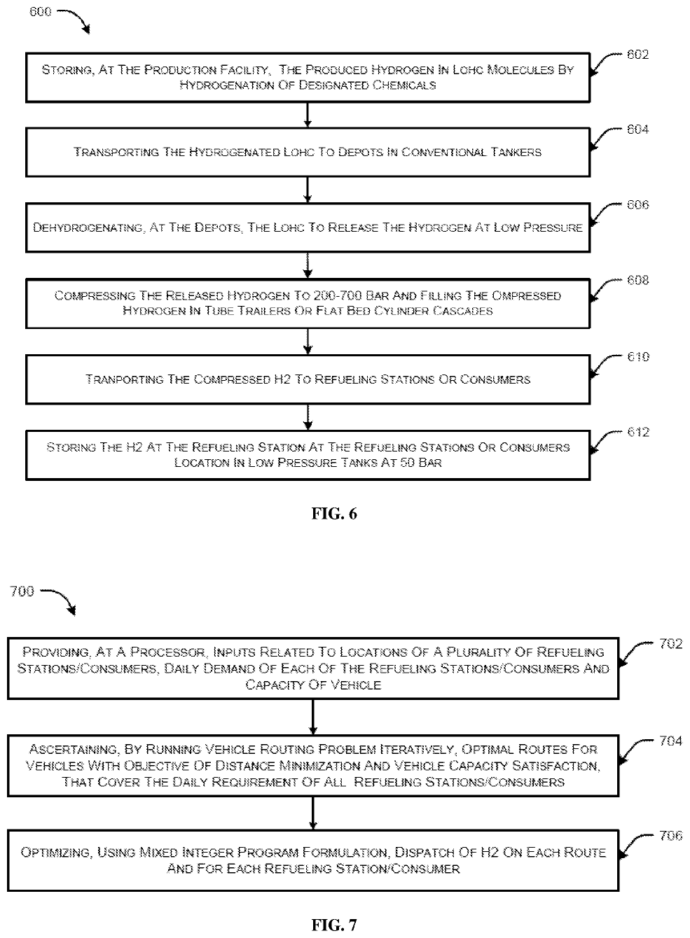

FIG. 6 illustrates an exemplary flow diagram for a method (600) of distribution of hydrogen from the production facility (102) to consumption sites (108), in accordance with an embodiment of the present disclosure.

At block (602), the method (600) may include storing, at the production facility (102), the produced hydrogen in LOHC molecules by hydrogenation of designated chemicals, such as but not limited to Toluene or Di-benzyl Toluene (DBT).

At block (604), the method (600) may include transporting the hydrogenated LOHC from the production facility (102) to depots (106), in conventional tankers.

At block (606) the method (600) may include dehydrogenating, at the depots (106), the LOHC to release the hydrogen at low pressure, such as 50 bars.

At block (608), the method (600) may include compressing, at the depots (106), the released hydrogen to 200-700 bar and filling the compressed hydrogen in high-pressure tube trailers or flat-bed cylinder cascades.

At block (610) the method (600) may include transporting the compressed H₂ in the high-pressure tube trailers or flat-bed cylinder cascades from the depots (106) to consumption sites, such as consumption sites (108).

At block (612) the method (600) may include storing the H₂ at the consumption sites (108) in low-pressure tanks at 50 bars, from where it can be compressed to 500-900 bar for storage into high-pressure buffer cylinders for dispensing into onboard cylinders of the vehicle at 350 bars in case of heavy vehicles or 700 bar in case of cars/taxis.

In an aspect, the method can also include ascertaining, by running vehicle routing problem (VRP) iteratively, optimal routes from the depots to the consumption sites, with the objective of distance minimization and vehicle capacity satisfaction, that cover the daily requirement of all consumption sites (108), and can further include optimizing, using mixed-integer program (MIP) formulation, dispatch of H₂ on each route and for each consumption sites 108.

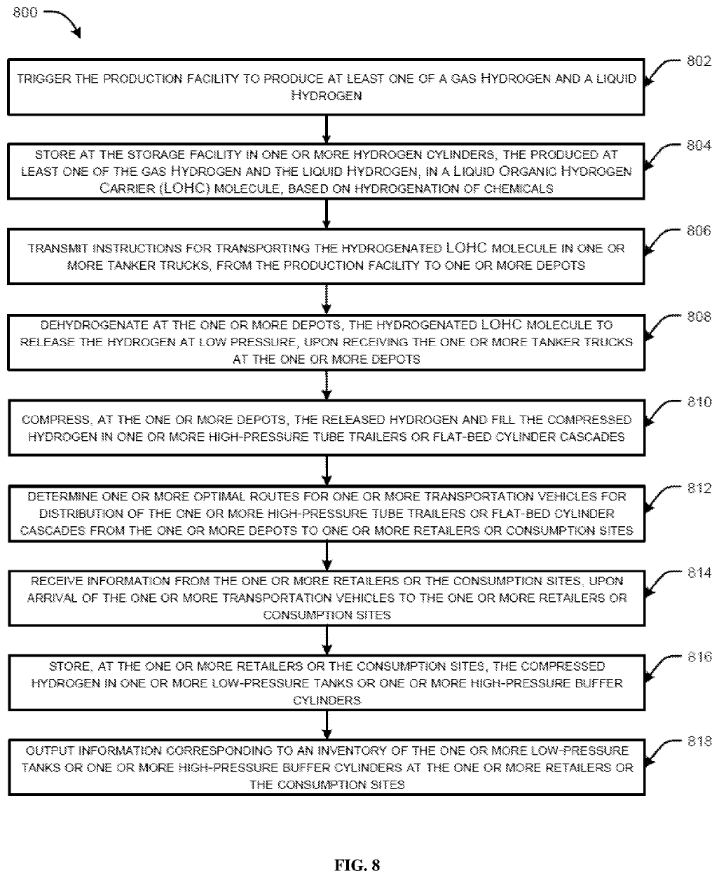

FIG. 7 illustrates an exemplary flow diagram for a method (700) of optimization of the distribution of hydrogen from the depot (106) to consumption sites (108), in accordance with an embodiment of the present disclosure.

At block (702), the method (700) may include providing, inputs related to locations of a plurality of consumption sites, such as consumption sites (108), daily demand of each of the consumption sites (108), and capacity of the vehicle.

At block (704) the method (700) may include ascertaining, by running vehicle routing problem (VRP) iteratively, optimal routes for vehicles, with the objective of distance minimization and vehicle capacity satisfaction, that cover the daily requirement of all consumption sites (108).

At block (706) the method (700) may include optimizing, using mixed-integer program (MIP) formulation, dispatch of H₂ on each route, and for each consumption site (108).

It is to be appreciated that while the proposed method (700) for optimization of the distribution of hydrogen from a depot to consumption sites (108) has been described with reference to the distribution of LOHC, the concept disclosed herein can be applied to other products as well, such as but not limited to liquid hydrogen, Ammonia, Methanol, and any other similar product, without any limitations whatsoever.

FIG. 8 illustrates an exemplary method flow chart depicting a method (800) for optimizing the supply chain of the hydrogen distribution network, in accordance with an embodiment of the present disclosure.

As illustrated in FIG. 8, the method (800) includes one or more blocks illustrating a method of optimizing the supply chain of the hydrogen distribution network. The method (800) may be described in the general context of computer-executable instructions. Generally, computer-executable instructions can include routines, programs, objects, components, data structures, procedures, modules, and functions, which perform functions or implement abstract data types.

The order in which the method (800) is described is not intended to be construed as a limitation, and any number of the described method blocks can be combined in any order to implement the method (800). Additionally, individual blocks may be deleted from the methods without departing from the scope of the subject matter described herein. Furthermore, the method (800) can be implemented in any suitable hardware, software, firmware, or combination thereof.

At block (802), the method (800) may include triggering, by a processor (202) associated with a centralized server (110), the production facility (102) to produce at least one of a gas Hydrogen and a liquid Hydrogen.

At block (804), the method (800) may include storing, by the processor (202), at the storage facility (104) in one or more hydrogen cylinders, the produced at least one of the gas Hydrogen and the liquid Hydrogen, in a Liquid Organic Hydrogen Carrier (LOHC) molecule, based on hydrogenation of chemicals.

At block (806), the method (800) may include transmitting, by the processor (202), instructions for transporting the hydrogenated LOHC molecule in one or more tanker trucks, from the production facility (102) to one or more depots (106).

At block (808), the method (800) may include dehydrogenating, by the processor (202), at the one or more depots (106), the hydrogenated LOHC molecule to release the hydrogen at low pressure, upon receiving the one or more tanker trucks at the one or more depots (106).

At block (810), the method (800) may include compressing, by the processor (202), at the one or more depots (106), the released hydrogen and fill the compressed hydrogen in one or more high-pressure tube trailers or flat-bed cylinder cascades.

At block (812), the method (800) may include determining, by the processor (202), one or more optimal routes for one or more transportation vehicles for distribution of the one or more high-pressure tube trailers or flat-bed cylinder cascades from the one or more depots (106) to one or more retailers or consumption sites (108).

At block (814), the method (800) may include receiving, by the processor (202), information from the one or more retailers or the consumption sites (108), upon arrival of the one or more transportation vehicles to the one or more retailers or consumption sites (108).

At block (816), the method (800) may include storing, by the processor (202), at the one or more retailers or the consumption sites (108), the compressed hydrogen in one or more low-pressure tanks or one or more high-pressure buffer cylinders.

At block (818), the method (800) may include outputting, by the processor (202), information corresponding to an inventory of the one or more low-pressure tanks or one or more high-pressure buffer cylinders at the one or more retailers or the consumption sites (108).

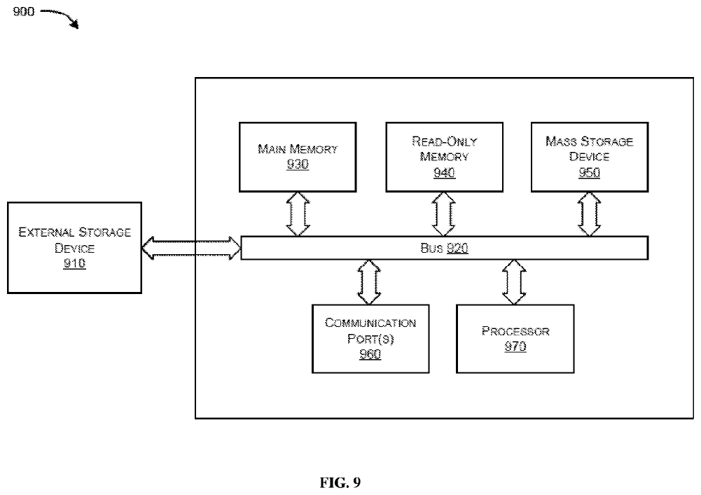

FIG. 9 illustrates an exemplary computer system (900) in which or with which embodiments of the present invention can be utilized, in accordance with embodiments of the present disclosure.

As shown in FIG. 9, the computer system (900) can include an external storage device (910), a bus (920), a main memory (930), a read-only memory (940), a mass storage device (950), communication port (960), and a processor (970). A person skilled in the art will appreciate that the computer system may include more than one processor and communication ports. Examples of processor (970) include, but are not limited to, an Intel® Itanium® or Itanium 2 processor(s), or AMD® Opteron® or Athlon MP® processor(s), Motorola® lines of processors, FortiSOC™ system on chip processors or other future processors. Processor (970) may include various modules associated with embodiments of the present invention. Communication port (960) can be any of an RS-232 port for use with a modem-based dialup connection, a 10/100 Ethernet port, a Gigabit, or 10 Gigabit port using copper or fiber, a serial port, a parallel port, or other existing or future ports. Communication port (960) may be chosen depending on a network, such as a Local Area Network (LAN), Wide Area Network (WAN), or any network to which the computer system connects. Memory (930) can be Random Access Memory (RAM), or any other dynamic storage device commonly known in the art. Read-only memory (940) can be any static storage device(s) e.g., but not limited to, a Programmable Read-Only Memory (PROM) chips for storing static information e.g., start-up or BIOS instructions for the processor (970). Mass storage (950) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 782 family) or Hitachi (e.g., the Hitachi Deskstar 13K800), one or more optical discs, Redundant Array of Independent Disks (RAID) storage, e.g. an array of disks (e.g., SATA arrays), available from various vendors.

Bus (920) communicatively couples' processor(s) (970) with the other memory, storage, and communication blocks. Bus (920) can be, e.g., a Peripheral Component Interconnect (PCI)/PCI Extended (PCI-X) bus, Small Computer System Interface (SCSI), USB or the like, for connecting expansion cards, drives, and other subsystems as well as other buses, such a front side bus (FSB), which connects processor (970) to a software system.

Optionally, operator and administrative interfaces, e.g., a display, keyboard, and a cursor control device, may also be coupled to the bus (920) to support direct operator interaction with a computer system. Other operator and administrative interfaces can be provided through network connections connected through a communication port (960). The external storage device (910) can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

Various embodiments of the present disclosure provide a system and a method for optimizing the supply chain of the hydrogen distribution network. The present disclosure enables transporting, distributing, and storing hydrogen to meet requirements at consumption sites, such as but not limited to retailers, refueling stations for fueling vehicles being run on hydrogen as a clean fuel, and other consumers, who may be using hydrogen a source of energy. The present disclosure helps in transporting the hydrogen from the production facility to depots based on a Liquid Organic Hydrogen Carrier molecule (LOHC) technology and from the depots to consumption sites as Compressed Gas Hydrogen (CGH₂). The LOHC technology may enable to transport of 4-5 times more H₂ than Compressed Gas Hydrogen (CGH₂) in a given truck. Further, being liquid at ambient conditions, LOHC is easy to handle, transport, and store using the same infrastructure as liquid fuels. Since one of the chemicals used for storing H₂, i.e., Di-benzyl Toluene DBT, is non-flammable and non-explosive, it has a lower risk than the other, i.e., Toluene, for transportation and storage. The present disclosure helps in finding optimal routes from the depots to the consumption sites, such as refueling stations for vehicles, with the objective of distance minimization and vehicle capacity satisfaction, that cover the daily requirement of all consumption sites, and further include optimizing, dispatch of H₂ on each route and for each consumption sites.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as a limitation.

We claim:

1. A system (100) for optimizing supply chain of hydrogen distribution network, the system (100) comprising:
a production facility (102);
a storage facility (104) communicatively coupled to the production facility (102);
one or more depots (106) communicatively coupled to the storage facility (104);
one or more retailers or consumption sites (108) communicatively coupled to the one or more depots (106);
a centralized server (110) comprising a processor (202) and a memory (204) coupled to the processor (202), wherein the memory (204) comprises processor-executable instructions, which in execution, causes the processor (202) to:
trigger the production facility (102) to produce at least one of a gas Hydrogen and a liquid Hydrogen;
store at the storage facility (104) in one or more hydrogen cylinders, the produced at least one of the gas Hydrogen and the liquid Hydrogen, in a Liquid Organic Hydrogen Carrier (LOHC) molecule, based on hydrogenation of chemicals;
transmit instructions for transporting the hydrogenated LOHC molecule in one or more tanker trucks, from the production facility (102) to one or more depots (106);
dehydrogenate at the one or more depots (106), the hydrogenated LOHC molecule to release the hydrogen at low pressure, upon receiving the one or more tanker trucks at the one or more depots (106);
compress, at the one or more depots (106), the released hydrogen and fill the compressed hydrogen in one or more high-pressure tube trailers or flat-bed cylinder cascades;
determine one or more optimal routes for one or more transportation vehicles for distribution of the one or more high-pressure tube trailers or flat-bed cylinder cascades from the one or more depots (106) to one or more retailers or consumption sites (108);
receive information from the one or more retailers or the consumption sites (108), upon arrival of the one or more transportation vehicles to the one or more retailers or consumption sites (108);
store, at the one or more retailers or the consumption sites (108), the compressed hydrogen in one or more low-pressure tanks or one or more high-pressure buffer cylinders; and
output information corresponding to an inventory of the one or more low-pressure tanks or one or more high-pressure buffer cylinders at the one or more retailers or the consumption sites (108).

2. The system (100) as claimed in claim 1, wherein the hydrogenation of chemicals comprises Toluene or Di-benzyl Toluene (DBT), and the hydrogenated LOHC can be stored at the storage.

3. The system (100) as claimed in claim 1, wherein for determining the one or more optimal routes for one or more transportation vehicles, the processor (202) is further configured to ascertain iteratively vehicle routing problem for optimal routes, based on distance minimization and vehicle capacity satisfaction, for daily requirement of the one or more retailers or the consumption sites (108).

4. The system (100) as claimed in claim 1, wherein the one or more depots (106) are geographically located to cater to requirements of the one or more retailers or the consumption sites (108) located in a geographical area around the respective depots (106), wherein the requirements comprising of transporting hydrogen from the storage of the production facility (102) to the one or more depots (106) is highly considerable than that from the one or more depots (106) to the consumption sites (108).

5. The system (100) as claimed in claim 1, wherein for outputting, the processor (202) is further configured to provide a graph with connected one or more retailers or the consumption sites (108) that would be served by the transportation vehicles via the one or more optimal routes, and wherein, when the one or more retailers or the consumption sites (108) does not have a route in which the one or more retailers or the consumption sites (108) are connected to another one or more retailers or the consumption sites (108), such one or more retailers or the consumption sites (108) is considered independently.

6. The system (100) as claimed in claim 1, wherein transmitting instructions for transporting the hydrogenated LOHC molecule in one or more tanker trucks, from the production facility (102) to one or more depots (106) is based on LOHC supply chain technique, and wherein distribution of the one or more high-pressure tube trailers or flat-bed cylinder cascades from the one or more depots (106) to one or more retailers or consumption sites (108) compressed hydrogen supply chain technique.

7. A method for optimizing supply chain of hydrogen distribution network, the method comprising:
triggering, by a processor (202) associated with a centralized server (110), a production facility (102) to produce at least one of a gas Hydrogen and a liquid Hydrogen;
storing, by the processor (202), at a storage facility (104) in one or more hydrogen cylinders, the produced at least one of the gas Hydrogen and the liquid Hydrogen, in a Liquid Organic Hydrogen Carrier (LOHC) molecule, based on hydrogenation of chemicals;
transmitting, by the processor (202), instructions for transporting the hydrogenated LOHC molecule in one or more tanker trucks, from the production facility (102) to one or more depots (106);
dehydrogenating, by the processor (202), at the one or more depots (106), the hydrogenated LOHC molecule to release the hydrogen at low pressure, upon receiving the one or more tanker trucks at the one or more depots (106);
compressing, by the processor (202), at the one or more depots (106), the released hydrogen and fill the compressed hydrogen in one or more high-pressure tube trailers or flat-bed cylinder cascades;
determining, by the processor (202), one or more optimal routes for one or more transportation vehicles for distribution of the one or more high-pressure tube trailers or flat-bed cylinder cascades from the one or more depots (106) to one or more retailers or consumption sites (108);
receiving, by the processor (202), information from the one or more retailers or the consumption sites (108), upon arrival of the one or more transportation vehicles to the one or more retailers or consumption sites (108);
storing, by the processor (202), at the one or more retailers or the consumption sites (108), the compressed hydrogen in one or more low-pressure tanks or one or more high-pressure buffer cylinders; and
outputting, by the processor (202), information corresponding to an inventory of the one or more low-pressure tanks or one or more high-pressure buffer cylinders at the one or more retailers or the consumption sites (108).

8. The method as claimed in claim 7, wherein the hydrogenation of chemicals comprises Toluene or Di-benzyl Toluene (DBT), and the hydrogenated LOHC can be stored at the storage.

9. The method as claimed in claim 7, wherein determining the one or more optimal routes for one or more transportation vehicles, further comprises ascertaining, by the processor (202), iteratively vehicle routing problem for optimal routes, based on distance minimization and vehicle capacity satisfaction, for daily requirement of the one or more retailers or the consumption sites (108).

10. The method as claimed in claim 7, wherein the one or more depots (106) are geographically located to cater to requirements of the one or more retailers or the consumption sites (108) located in a geographical area around the respective depots (106), wherein the requirements comprising of transporting hydrogen from the storage of the production facility (102) to the one or more depots (106) is highly considerable than that from the one or more depots (106) to the consumption sites (108).

11. The method as claimed in claim 7, wherein outputting further comprises providing, by the processor (202), a graph with connected one or more retailers or the consumption sites (108) that would be served by the transportation vehicles via the one or more optimal routes, and wherein, when the one or more retailers or the consumption sites (108) does not have a route in which the one or more retailers or the consumption sites (108) are connected to another one or more retailers or the consumption sites (108), such one or more retailers or the consumption sites (108) is considered independently.

12. The system (100) as claimed in claim 7, wherein transmitting instructions for transporting the hydrogenated LOHC molecule in one or more tanker trucks, from the production facility (102) to one or more depots (106) is based on LOHC supply chain technique, and wherein distribution of the one or more high-pressure tube trailers or flat-bed cylinder cascades from the one or more depots (106) to one or more retailers or consumption sites (108) compressed hydrogen supply chain technique.
